(19) United States
(12) Patent Application Publication
(10) Pub. No.: US 2022/0128694 A1
(43) Pub. Date: Apr. 28, 2022

(54) VEHICLE LIDAR SYSTEM INTERCONNECTED WITH LED HEAD LAMP

(71) Applicant: XAOS MOTORS CO., LTD., Seongnam-si, Gyeonggi-do (KR)

(72) Inventor: Su yeop YOO, Jecheon-si, Chungcheongbuk-do (KR)

(21) Appl. No.: 17/054,916

(22) PCT Filed: Sep. 23, 2020
(86) PCT No.: PCT/KR2020/012831

§ 371 Date: Nov. 12, 2020

(30) Foreign Application Priority Data
Apr. 16, 2020 (KR) 10-2020-0045765

(51) Int. Cl. G01S 17/894; H04N 13/296; G01S 7/481; G01S 17/931; B60Q 1/00; B60Q 1/14

(52) U.S. Cl. CPC G01S 17/894; H04N 13/296; B60Q 1/14; G01S 17/931; B60Q 1/0023; G01S 7/4814

(57) ABSTRACT

The present invention relates to a vehicle LiDAR system interconnected with an LED headlamp, which can extend a measurement distance by using a light source of a vehicle LED headlamp capable of emitting high-brightness light also as an illumination light source of a LiDAR, and compensate for decrease in resolution using a separate distance calculation algorithm. The present invention implements a vehicle LiDAR system interconnected with an LED headlamp, the system comprising: a lighting device for controlling brightness of a headlight according to a headlight brightness control signal of a vehicle, and transmitting a high-frequency light source synchronized with an operating frequency and a phase of a LiDAR; a 3D image device for transferring a synchronization signal synchronized with the operating frequency and the phase of the LiDAR to the lighting device, measuring a phase delay by comparing a phase detected from light received from a subject and the phase provided to the lighting device, and outputting a distance measurement signal measuring the distance to the subject generated from the measured phase delay as a 3D image signal; and a distance calculation unit for performing a long distance and precise distance calculation by combining the 3D image signal output through the 3D image device.

### TECHNICAL FIELD

The present invention relates to a vehicle LiDAR system interconnected with an LED headlamp, and more specifically, to a vehicle LiDAR system interconnected with an LED headlamp, which can extend a measurement distance by using a light source of a vehicle LED headlamp capable of emitting high-brightness light also as an illumination light source of a LiDAR, and compensate for decrease in resolution using a separate distance calculation algorithm.

### BACKGROUND ART

Generally, a LiDAR system is a detection device for detecting a distance between a subject and a LiDAR body by sequentially emitting laser pulses in a short time and measuring a time of the emitted laser pulses being reflected from the subject and returning to the device.

FIG. 1 is a view showing the principle of a general LiDAR system including a light generating device 101, a lens 102, a light receiving device 106, an output unit 105, a measurement unit 107, a control unit 108, and a communication unit 111.

In FIG. 1, reference symbol 10 denotes a subject to be detected, reference symbol 103 denotes laser pulse light emitted to the subject, and reference symbol 104 denotes reflective light reflected from the subject.

The light generating device 101 generates laser pulse light for detecting a subject according to driving current output from the output unit 105, and it may be configured of a laser diode for emitting the laser pulse light in association with the output unit 105, and a collimator for converting the laser pulse light emitted from the laser diode into parallel light.

The lens 102 focuses the laser pulse light transmitted through the light generating device 101 and emits the focused light to the subject 10, and focuses receiving light 104 reflected from the subject 10 and transmits the focused light to the light receiving device 106. The laser pulse light may be expanded and focused through the lens 102.

The light receiving device 106 converts the receiving light focused through the lens 102 into an electrical signal to generate a detection signal, and the measurement unit 107 amplifies and converts the generated detection signal into a digital signal, and transfers the digital signal to the control unit 108 as a measurement signal. The light receiving device 106 may include a receiving diode for converting the received optical signal into an electrical signal.

The control unit 108 controls to store the measurement signal transferred from the measurement unit 107 as a scan data, detect existence of an object and physical quantity thereof based on the scan data, and transmit the scan data to an upper control terminal. To this end, the control unit 108 includes a memory for storing the scan data therein, a data analyzer for detecting existence of an object and physical quantity thereof from the detection data, a control module for controlling storage of the scan data and controlling communication of the detected scan data.

The communication unit 111 performs a function of transmitting the scan data to the upper control terminal in association with the control unit 108, and interfacing commands transmitted from the upper control terminal to the control unit 108.

In the LiDAR system like this, a module for emitting and receiving light has been developed in various types including a type of measuring light 360 degrees using a mechanical rotation device, a type of seeing only the front side using a fixed light receiving device, a type of a 3D image sensor connecting several optical sensors horizontally and vertically, and the like.

Among them, an integrated circuit of a device using a 3D image sensor in which several optical sensors are connected horizontally and vertically, i.e., a LiDAR sensor of a 3D camera form (3D ToF Image Sensor; 3 Dimension Time of Flight Image Sensor), is shown in FIG. 2.

The 3D ToF Image Sensor is a device for measuring a distance to a subject by emitting light to the subject from a high-speed light source and measuring a time of the light returning and reaching the light-receiving sensor. Hundreds of light-receiving elements are arranged horizontally and vertically in the light-receiving sensor, and each light receiving-element measures how much the light starting from the light source is delayed. There is a focusing lens in front of the light-receiving sensor and measures the distance to the subject of which an image is formed.

At this point, the method of measuring the delay time of light by each light-receiving element is largely divided into two methods, including a method of measuring delay of light pulse starting from a light generator and arriving at the light-receiving element using a device having a light source turned on and off at a high speed, and a method of measuring a phase delay between a generated optical signal and a received optical signal by an element which generates and receives a high-frequency optical signal.

Since the former method uses light turned on and off very quickly and thus may not generate strong light energy, a method of intensively emitting and receiving light only at one point using a lens is used. Therefore, in order to scan an entire area to be measured, a method of sequentially measuring a delay using several light pulses is used. A device adopting this method has been developed in various ways, including devices that scan a light generating device and a light receiving device in a mechanical method or measures delay of light pulse by reflecting light using a mirror.

The latter method of measuring a distance by generating high-frequency light and measuring a phase delay of the light has been developed into a device called as Theodolite, and this is a method of measuring a distance to a subject by emitting high-speed modulated light and measuring the phase of the emitted light and the phase of the light reflected and returned from the subject.

An image may be three-dimensionally measured using an arrival time of light measured by each light-receiving element, and a LiDAR system of a 3D ToF Image Sensor type previously proposed using this function is disclosed in <Patent document 1>.

In addition, another conventional technique for transmitting and receiving laser light by a driving unit rotating like a mechanical LiDAR is disclosed in <Patent document 2>.

Since the LiDAR system disclosed in <Patent Document 1>has no mechanical movement, a stable LiDAR equipment can be made. In addition, as 3D measurement data is generated like a camera image, it is easy to handle the data.

A series of operations like this and a device configured as such are developed as an integrated circuit by using currently developed techniques, and devices using the integrated circuit are implemented. However, since there is a limit in the brightness and light emission of the LiDAR light source of this method, there is a limit in that they are used only as a measurement LiDAR in a nearby place.

### DISCLOSURE OF INVENTION

### Technical Problem

Therefore, the present invention has been made in view of the above problems, and it is an object of the present invention to provide a vehicle LiDAR system interconnected with an LED headlamp, which can extend a measurement distance by using a light source of a vehicle LED headlamp capable of emitting high-brightness light also as an illumination light source of a LiDAR, and compensate for decrease in resolution using a separate distance calculation algorithm.

### Technical Solution

To accomplish the above object, according to one aspect of the present invention, there is provided a vehicle LiDAR system interconnected with an LED headlamp, the system comprising: a lighting device for controlling brightness of a headlight according to a headlight brightness control signal of a vehicle, and transmitting a high-frequency light source synchronized with an operating frequency and a phase of a LiDAR; and a 3D image device for transferring a synchronization signal synchronized with the operating frequency and the phase of the LiDAR to the lighting device, measuring a phase delay by comparing a phase detected from light received from a subject and the phase provided to the lighting device, and outputting a distance measurement signal measuring the distance to the subject generated from the measured phase delay as a 3D image signal.

In addition, the “vehicle LiDAR system interconnected with an LED headlamp” according to the present invention further comprises a distance calculation unit for performing a long distance and precise distance calculation by combining the 3D image signal output through the 3D image device.

The lighting device is implemented as an LED headlamp of the vehicle.

The lighting device includes: a headlight brightness controller for generating a headlight brightness control signal according to a headlight control signal; a synchronization signal operator for generating an operating frequency and a phase synchronization signal of the LiDAR according to a reference frequency generated by a reference frequency generator; a current controller for controlling brightness of the headlight through current control according to the headlight brightness control signal generated by the headlight brightness controller, and outputting a high-frequency current synchronized with the operating frequency and the phase of the LiDAR generated by the synchronization signal operator; and a light source transmitter for transmitting a high-frequency light source according to the high-frequency current of the current controller.

When the operating frequency and the phase of the LiDAR are changed, the high-frequency of the high-frequency light source is also changed.

The light source transmitter includes an LED for transmitting the high-frequency light source synchronized with the operating frequency and the phase of the LiDAR.

The light source transmitter includes: a first LED for transmitting a light source for the headlamp; and a second LED for outputting a LiDAR signal synchronized with the operating frequency and the phase of the LiDAR.

The 3D image device includes: a lens for focusing and outputting receiving light reflected from the subject; a light receiving unit for converting the receiving light focused through the lens into an electrical signal; a phase discriminator for detecting a phase of the electrical signal output from the light receiving unit in proportion to a frequency generated by a reference frequency generator; a phase delay measurement device for measuring a phase delay by comparing the phase detected by the phase discriminator with a phase of the high-frequency light source, and generating a distance measurement signal measuring a distance to the subject using the measured phase delay; a controller for controlling generation of the reference frequency of the reference frequency generator, transferring the phase of the high-frequency light source to the phase delay measurement device, and controlling output of a 3D image; and a 3D image buffer for buffering the distance measurement signal measuring a distance to the subject output from the phase delay measurement device according to 3D image output control of the controller, and outputting a 3D image signal.

The light receiving unit includes a plurality of light receiving elements arranged horizontally and vertically.

### Advantageous Effects

According to the present invention, there is an advantage of extending a measurement distance by using a light source of a vehicle LED headlamp capable of emitting high-brightness light also as an illumination light source of a LiDAR, and an advantage of compensating for decrease in resolution according to the expansion of the measurement distance by using a separate distance calculation algorithm.

### BRIEF DESCRIPTION OF THE DRAWINGS

FIG. 1 is a view showing the principle of a general LiDAR system.

FIG. 2 is a view showing the configuration of a 3D image integrated circuit applied to the prior art and the present invention.

FIG. 3 is a view showing the configuration of a vehicle LiDAR system interconnected with an LED headlamp according to the present invention.

FIG. 4 is a view showing an example of seeing the front side of a LiDAR system in the present invention.

FIG. 5 is a view showing an example of applying the present invention to a vehicle.

FIG. 6 is a view showing a pulse time delay of a LiDAR operating by light of pulses.

FIG. 7 is a view showing the principle of phase delay of a LiDAR operating in a phase delay method.

FIG. 8 is a view showing an example of delay time measured by a LiDAR scanning at various frequencies.

FIG. 9 is a view showing an example of a lighting device that transmits headlamp and LiDAR signals using a single LED according to the present invention.

FIG. 10 is a view showing an example of a lighting device transmitting a light source and a signal by separating a headlamp LED and an LED for generating a LiDAR signal according to the present invention.

### BEST MODE FOR CARRYING OUT THE INVENTION

Hereafter, a vehicle LiDAR system interconnected with an LED headlamp according to a preferred embodiment of the present invention will be described in detail with reference to the accompanying drawings.

The terms or words used in the present invention described below should not be interpreted as being limited to a conventional or dictionary meaning, and should be interpreted as a meaning and concept conforming to the technical spirit of the present invention based on the principle that the inventors can appropriately define the concept of terms in order to describe his or her own invention in the best way.

Therefore, since the embodiments described in the present specification and the configurations shown in the drawings are only preferred embodiments of the present invention and do not represent all the technical spirit of the present invention, it should be understood that there may be various equivalents and modified examples that can replace them at the time point of the present application.

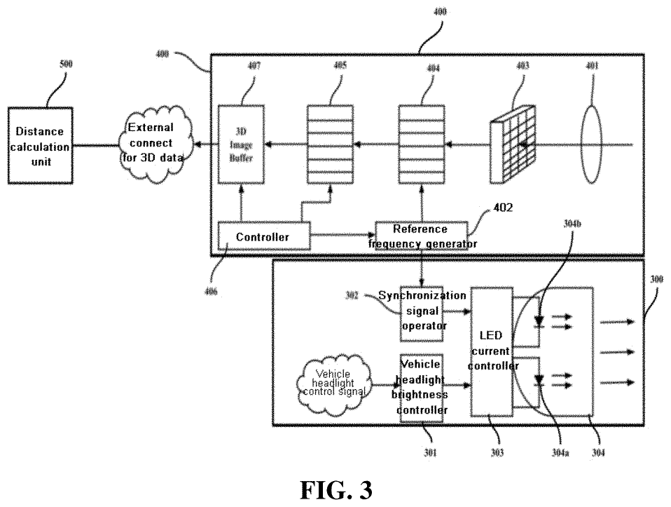

FIG. 3 is a view showing the configuration of a vehicle LiDAR system interconnected with an LED headlamp according to the present invention, and the vehicle LiDAR system includes a lighting device 300, a 3D image device 400, and a distance calculation unit 500.

The lighting device 300 controls brightness of a headlight according to a headlight brightness control signal, and performs a function of transmitting a high-frequency light source synchronized with the operating frequency and the phase of the LiDAR.

The lighting device 300 like this may be implemented as an LED headlamp provided in a vehicle.

Here, the LED headlamp is applied to almost all vehicles recently, and the LED headlamp of a vehicle is a light source developed for the purpose of emitting light to the front side, and has a form and a function suitable for being applied and used in a LiDAR for 3D image measurement of measuring an object on the front side. The function of focusing and emitting light, together with an amount of light sufficient for emitting light up to several hundred meters, is excellent. Moreover, as the LED may operate at a high speed, it can be used as a light source of the LiDAR, and when a lighting function for the LiDAR is added to the original headlamp light source of a vehicle, the distance of applying the LiDAR may be extended as much as hundreds of meters or more.

Headlamps that are in operation currently are configured in a structure of outputting a desired luminous flux by supplying a constant current to the LED, and obtaining a desired luminance by supplying the luminous flux to the front side through a focusing lens and a reflector. The headlamp is very useful for emitting light in the forward direction as a lot of research has been made on the optical field to efficiently operate the LED, and when the headlamp is used as a light source of a LiDAR, it can be applied as a very excellent light source since it may use existing excellent optical properties.

Therefore, in the present invention, an LED current supply circuit of a vehicle headlamp may be configured as a circuit capable of interworking with a light output request signal of the LiDAR, and since the lighting device 300 is configured to operate as a headlamp when needed, and it may perform two functions of a light source of the LiDAR and a headlamp.

The lighting device 300 includes a headlight brightness controller 301 for generating a headlight brightness control signal according to a headlight control signal, a synchronization signal operator 302 for generating an operating frequency and a phase synchronization signal of the LiDAR according to a reference frequency generated by a reference frequency generator provided in the 3D image device 400, a current controller 303 for controlling brightness of the headlight through current control according to the headlight brightness control signal generated by the headlight brightness controller 301, and outputting a high-frequency current synchronized with the operating frequency and the phase of the LiDAR generated by the synchronization signal operator 302, and a light source transmitter 304 for transmitting a high-frequency light source according to the high-frequency current of the current controller 303.

When the headlight brightness controller 301 receives the headlight control signal (headlight on/off signal, headlight brightness signal) from a control device of a vehicle (e.g., Vehicle Control Unit (VCU)) through CAN communication or the like, it transfers a headlight on/off control signal and a headlight brightness control signal for controlling headlight brightness to the current controller 303 based on the headlight control signal.

In addition, the synchronization signal operator 302 transfers a synchronization signal synchronized with the operating frequency and the phase of the LiDAR to the current controller 303 using the reference frequency of the LiDAR generated by the 3D image device 400. When the operating frequency and the phase of the LiDAR are changed, the synchronization signal operator 302 generates a synchronization signal synchronized with the operating frequency and the phase of the LiDAR so that the high frequency of the high-frequency light source transmitted from the light source transmitter 304 may also be changed.

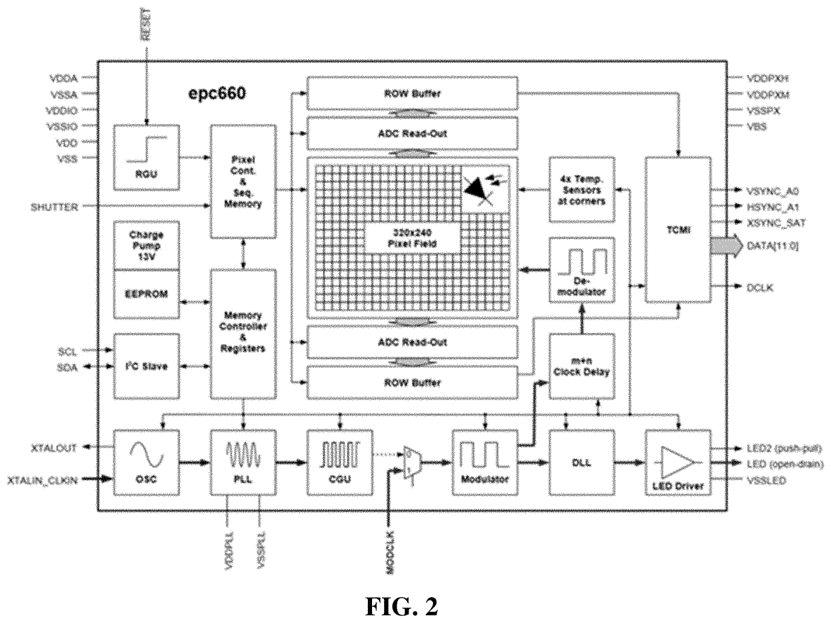

The current controller 303 is configured as a 3D image integrated circuit as shown in FIG. 2 and has a built-in circuit for driving the LED. The current controller 303 controls the LED by inputting a synchronization signal synchronized with the operating frequency and the phase of the LiDAR output from the synchronization signal operator 302 into the circuit driving the LED so that the headlight (headlamp) LED may flash in synchronization with the signal of the LiDAR at a high speed. Here, the flashing speed of the headlight LED is several hundred KHz, several MHz, or several hundred MHz, which is synchronized with the operating frequency and the phase of the LiDAR.

The light source transmitter 304 transmits a high-frequency light source synchronized with the operating frequency and the phase of the LiDAR using LED headlamps 304a and 304b. Here, the LED headlamp 304a means a left-side headlamp, and the LED headlamp 304b means a right-side headlamp. The left-side and right-side headlights emit the same high-frequency light source.

As a general LiDAR system lacks an appropriate light source and has a difficulty in long distance measurement, a LiDAR system currently applied to vehicles has implemented only LiDAR for a short range.

The reason that the current LiDAR system cannot be used for long distance measurement is lack of a strong light source capable of transmitting light to a long distance and decrease in resolution when the distance is extended over a long distance.

Accordingly, the present invention implements a LiDAR capable of long-distance scanning by adding a function of generating a high-frequency light source to an LED headlamp mounted on a vehicle.

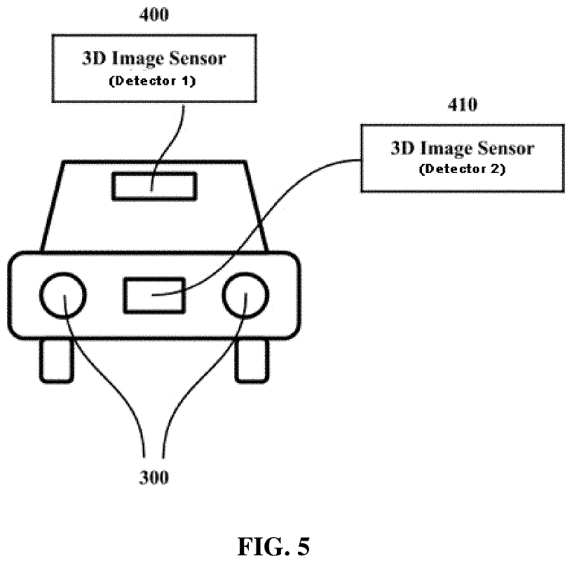

FIG. 5 is an example of implementing a LiDAR system equipped with a 3D image device 400 installed at a predetermined position in a vehicle to be capable of transmitting a high-frequency light source to the LED headlamp 300 basically provided in a vehicle through a high-frequency light source generation function, receiving light reflected from a subject and measuring a distance, and extracting 3D data like a camera. Here, the LiDAR system may be implemented using only a single 3D image device 410, and the 3D image device 410 may be additionally used for preciseness or the like.

The light of an LED headlamp mounted on a vehicle may be emitted up to several hundred meters, and a special headlamp has an ability of emitting light up to several kilometers at night. Currently, LEDs are widely used as a light source of a headlamp, and LED headlamps are stably operated by supplying current to the LED, and overheating of the LED is prevented by using a separate cooling device. The headlamp light may be used for the LiDAR by adding a headlamp control integrated circuit as shown in FIG. 2 to the LED headlamp.

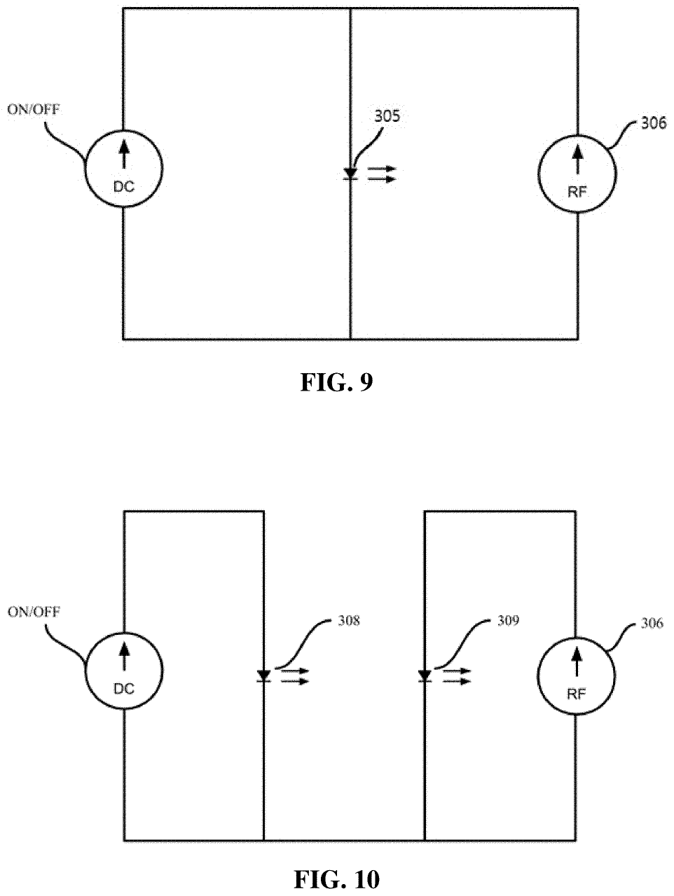

FIG. 9 is a view showing an example of using headlamp light for a LiDAR, in addition to the headlight, by adding a synchronization signal synchronized with the operating frequency and the phase of the LiDAR to a single LED headlamp 305.

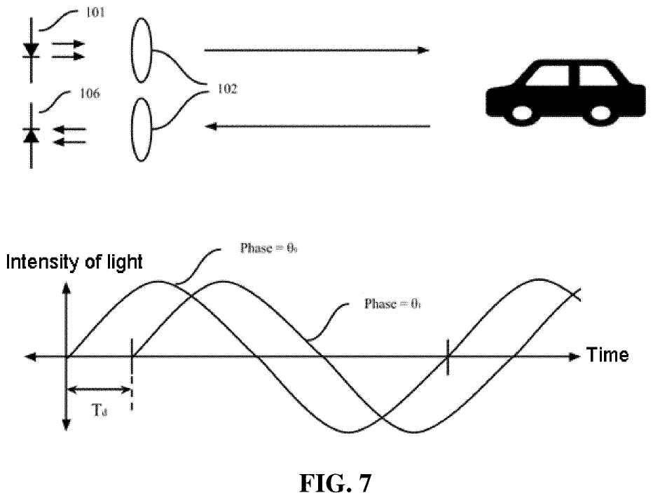

Here, the light emitted from the LED headlamp is emitted as light synchronized with the operating frequency and the phase required inside the LiDAR as shown in FIG. 7.

As AC current of various frequency bands synchronized with the operating frequency and the phase of the LiDAR flows through the headlamp as described above, the LED headlamp may be used as lighting of the LiDAR without hindering the function of the headlamp.

When the LED is turned on at a brightness that a human body may sense and an average current and an amount of light that are required are similar to those of existing headlamps, the headlamp may operate at a stable brightness that the driver of a vehicle may not feel the difference. In the case of a LiDAR that uses light of a different wavelength band according to a LiDAR type, the headlamp may be manufactured by adding an LED of a wavelength band corresponding to the headlamp.

That is, in some cases, when a LiDAR uses light of a special wavelength band within the infrared band, light for the LiDAR in an optimal wavelength range may be provided by adding a second LED 309 for the LiDAR to be separated from the first LED 308 for a headlamp light source as shown in FIG. 10.

Since the light of a different wavelength band emitted from the LED attached to the headlamp is different from the light of a wavelength band felt by a human body, it may operate to be almost independent from the function of the headlamp.

Meanwhile, the 3D image device 400 performs a function of transferring a synchronization signal synchronized with the operating frequency and the phase of the LiDAR to the lighting device 300, measuring a phase delay by comparing the phase detected from the light received from a subject and the phase provided to the lighting device 300, and outputting a distance measurement signal measuring the distance to the subject generated from the measured phase delay as a 3D image signal.

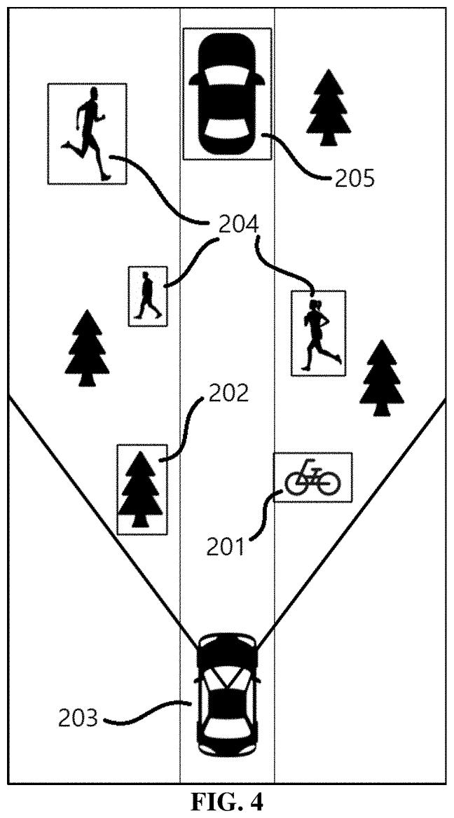

The 3D image device 400 is a unit for extracting 3D measurement data of several objects on front side as shown in FIG. 4. That is, as shown in FIG. 4, when there is a movement although the objects 204 and 205 are far from the LiDAR device, or when the motion is slow or the object 202 stands still, the 3D image device 400 extracts 3D measurement data.

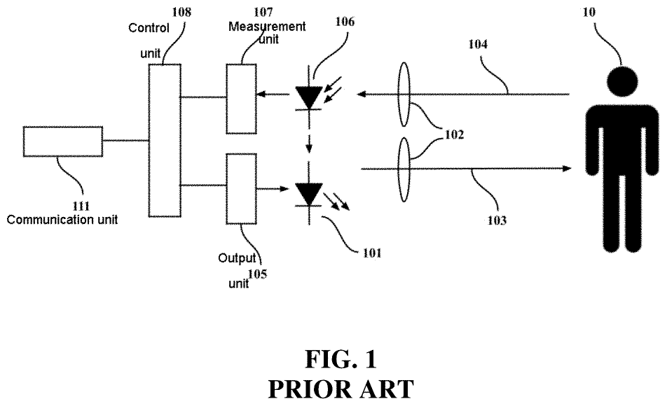

The LiDAR is a device of which the basic operation is to extract data that measures the time of light emitted to and returned from a subject as shown in FIG. 1, which has a structure of measuring data in a raster scan method by scanning left, right, up and down a set of a laser emitting unit and a light receiving unit, and measuring a distance to the subject by measuring the received and reflected times, or measuring a delay time of light emitted and returned in principle, in a form of emitting several laser beams and reducing scanning time by using several receiving modules.

A reference frequency generator 402 of the 3D image device 400 generates a reference frequency corresponding to the operating frequency of the LiDAR under the control of the controller 406, and transfers the reference frequency to the lighting device 300 and a phase discriminator 404. Here, the reference frequency is a frequency having the same phase as that of the operating frequency of the LiDAR. The controller 406 controls generation of the reference frequency of the reference frequency generator 402, transfers the phase of the high-frequency light source to a phase delay measurement device 405, and controls output of 3D images.

The light source emitted from the lighting device 300 is reflected by the subject, and the lens 401 focuses the receiving light reflected from the subject and transfers the light to the light receiving unit 403. Here, the light emitted from the light source to the subject is light having a predetermined frequency and phase, and the reflective light focused on the light receiving unit 403 through the lens 401 also has a frequency and a phase.

The light receiving unit 403 converts the receiving light focused through the lens 401 into an electrical signal and transfers the electrical signal to the phase discriminator 404. The light receiving unit 401 converts the receiving light into an electrical signal using hundreds of light receiving elements arranged vertically and horizontally.

The phase discriminator 404 detects the phase of the electrical signal output from the light receiving unit 403 in proportion to the frequency generated by the reference frequency generator 402.

Next, the phase delay measurement device 405 measures a phase delay by comparing the phase detected by the phase discriminator 404 with the phase of the high-frequency light source received from the controller 406, and generates a distance measurement signal measuring the distance to the subject using the measured phase delay.

Here, the phase delay measurement device 405 generates a distance measurement signal measuring the distance between the LiDAR and the subject using a distance measurement technique based on phase measurement profilometry.

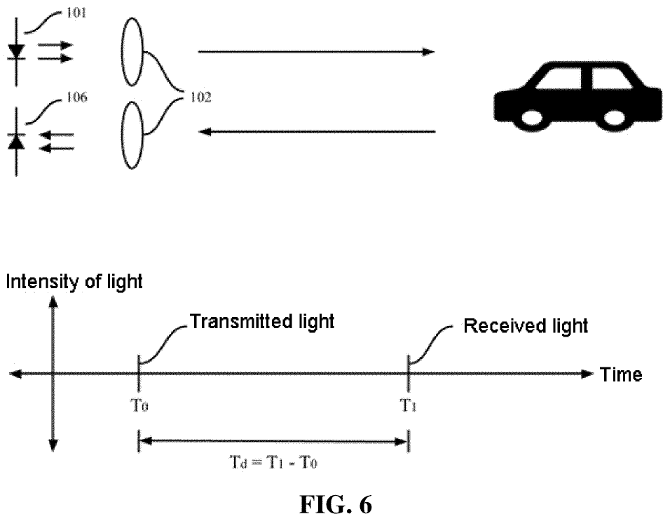

This technique has been developed into a technique of using a pulse that emits light for a very short period of time as shown in FIG. 6, and a technique of emitting cyclic continuous pulses as shown in FIG. 7. Although the technique of emitting pulses has a low distance resolution, it has been used for measuring a distance and a speed in a short time, and the technique of using cyclic continuous pulses has been developed to measure a distance to a comparatively fixed object. These techniques may be used to easily measure a distance by measuring the delay time of phase, like delay of pulse.

The integrated circuit that extends the distance measurement technique based on phase measurement profilometry is configured as shown in FIG. 2. As hundreds of light-receiving elements are arranged horizontally and vertically to form an image capable of extracting 3D data, implementation of a 3D camera is possible.

The operation of the LiDAR in FIG. 6 shows a case in which light of a pulse is delayed in a configuration of emitting light of a pulse type. In measuring the delay time (Td), the delay time may be directly read using a high-speed digital circuit, and since high-speed pulse signals are handled, a high-speed analog circuit and a digital circuit are required. To precisely measure a long distance, the number of bits in the digital circuit increases, and it will lead to a huge system.

FIG. 7 is a view showing a method of measuring a distance by continuously sending LED light modulated at a predetermined frequency, and it shows a method of measuring a distance by measuring a phase difference (θ_{d}=Phase θ₀−Phase θ₁) between emitted light and received light.

However, in case of using high-frequency light, the phase delay value of two signals is proportional to the frequency. In a short distance within one cycle, the phase difference (θ_{d}) due to the delay time of the emitted light is as shown in [Equation 1] below.

$${θ}_{d} = \frac{L}{{V}_{c}} \cdot {ω}_{o} [ rad ] \qquad [ Equation 1 ]$$

Here, L denotes a traveled distance of light, V_{c} denotes the speed of light, ω₀ denotes the angular frequency (2π×f) of light, and when the distance is longer than one cycle, the difference in the phase is as shown in [Equation 2] below.

$${θ}_{d} = \frac{L}{{V}_{c}} \cdot ( {ω}_{o} - 2 π n ) [ rad ] \qquad [ Equation 2 ]$$

Here, n is an integer.

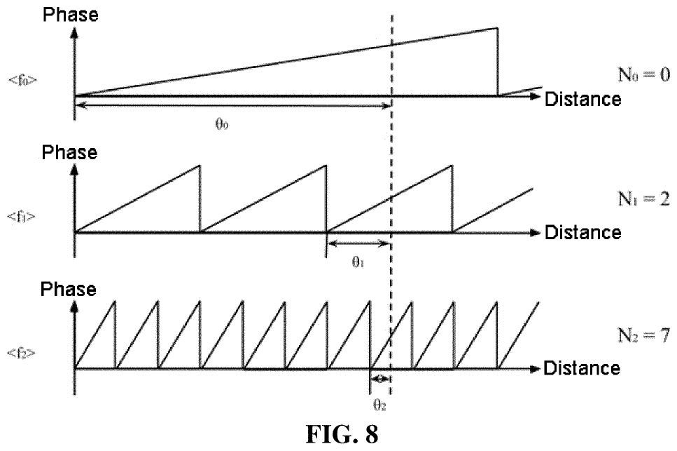

That is, a distance may be measured by precisely controlling the frequency and the phase of light in an emitted light source and precisely measuring the phase of received light. FIG. 8 is view showing an example of measuring a distance to a distant object using several frequencies (f₀, f₁, f₂) without degradation of accuracy. This operation measures a distance of light traveled from a light source to a light receiving pixel.

A method of measuring a phase delay by the phase delay measurement device 405 may be implemented by adopting the phase delay measurement method disclosed in US Patent Registration No. 4-113381 (Surveying Instrument and Method) as it is. The technique disclosed in the US patent is a method of measuring a phase delay using a conventional electronic circuit, and detailed description thereof will be omitted.

A phase difference value may be measured relatively easily and accurately compared to a measurement circuit using light of a pulse form. As a result, it is possible to configure a measurement device of a LiDAR, which can measure a distance more easily and is comparatively safer than strong impulsive light. However, in a real circuit, the limit in the resolution of a digital circuit is 10 bits or 12 bits. Accordingly, in the present invention, the resolution is enhanced by using various mathematical techniques.

That is, the phase delay measurement device 405 individually measures a phase delay of a plurality of receiving light obtained by using a plurality of light receiving elements of the light receiving unit 403, and transfers the phase delay to a 3D image buffer 407 as a distance measurement signal measuring the distance to a subject.

The 3D image buffer 407 buffers the distance measurement signal measuring the distance to the subject output from the phase delay measurement device 405 according to a 3D image output control of the controller 406, and outputs a 3D image signal.

The distance measurement data output as a 3D image signal is transferred to the distance calculation unit 500 connected through a network. The distance calculation unit 500 performs a long distance and precise distance calculation by combining the 3D image signal output through the 3D image device 400 using a distance calculation algorithm. Here, the distance calculation unit 500 may be located at a place far from the 3D image device 400 and receive and process 3D image data through a network, or may be implemented as a system integrated with the 3D image device 400 as needed. In the present invention, for the purpose of convenience, it is assumed that the distance calculation unit 500 is separate from the 3D image device.

When several frequencies are used together in measuring a distance, high resolution measurement is possible. In FIG. 8, when a phase delay is measured using a light source of a relatively low frequency f₀, phase delay θ₀ is measured. Although a delay time over a long distance is measured in this measurement, the distance resolution is limited by the limit of the phase measurement bits. For example, when a phase difference is measured using a digital device having a resolution of about 10 bits over a distance using light of a frequency (300 kHz) having a wavelength of 1000 m, an error of about 1 m should be accepted. However, when light of a 30 MHz frequency having a wavelength of 10 m is used, measurement within an error of 10 mm is possible when it is measured using a digital device having a resolution of about 10 bits. Since the light source has a wavelength of 30 MHz, values of the same phase difference are periodically measured as the measurement values even at a length of multiples of 10 m. Accordingly, the distance calculation unit 500 implements software (distance calculation algorithm) for measuring a distance to an object located at a long distance at several frequencies by using two advantages of the property of periodically measuring the phase difference and long-distance measurement of light of a long wavelength, and therefore, the LiDAR may perform a precise measurement through the software.

For example, when the distance is read as 301 m at 300 KHz and 1.23 m at 30 MHz, a distance of 301.23 m may be measured with a resolution of 10 cm.

The calculation is as follows.

For example, if it is assumed that the resolution of an internal digital phase measurement device is 10 bits when a distance of 301.23 m is measured, in the case where the phase read at 300 KHz corresponds to the phase of f₀ in FIG. 8,

$${θ}_{0} = \frac{301.23}{1 \text{,} 000} π [ rad ]$$

reads a measurement value of 308 as a 10-bit digital value, and in the case where the phase value read at 30 MHz corresponds to the phase of f2 in FIG. 8,

$${θ}_{2} = \frac{1.23}{10} π [ rad ]$$

measures a digital phase measurement value of 125 as a 10-bit digital value.

When a measurement value of θ₀ is inversely calculated, about

$$10 \times \frac{308}{1 \text{,} 024} = 300.78 [ m ]$$

is calculated.

In addition,

$$10 \times \frac{125}{1 \text{,} 024} = 1.221 [ m ]$$

is calculated at θ₂.

However, as for 1.221 [m], an object of 10 n+1.221 has the same value in the light having a wavelength of 30 MHz.

Here, since it is an object at a distance around 300 m, and it is a subject at a distance around 300 m obtained with a value of 00, it corresponds to the case where n is 30, so that a precise distance of 301.22 m is an accurate measurement value. That is, it is possible to operate a system having an error resolution of 1 cm. That is, since the distance error is 1 cm, which is 0.001% of 1000 m, a precise measurement value can be obtained. When high-frequency light of various frequencies is used as described above in the lighting device of a headlamp, it becomes a LiDAR that can measure an accurate distance to a distant object.

The measurement method like this is a method adopted in the US patent document, which is also a technique used in the Theodolite.

A LiDAR system having the functions like this may become a product of high reliability as it does not have mechanically moving parts, and it is an optically safe system since it does not use light that may be harmful to human bodies like a laser. The headlamp may also save the space in the LiDAR system by adding the LiDAR system to its own function. Moreover, since lighting of the headlamp is used for a LiDAR lighting device, long distance measurement can be implemented simply.

Although the present invention made by the present inventor has been described in detail according to the embodiment, the present invention is not limited to the embodiment, and it is apparent to those skilled in the art that various changes can be made without departing from the gist of the invention.

1. A vehicle LiDAR system interconnected with an LED headlamp, the system comprising:
a lighting device for controlling brightness of a headlight according to a headlight brightness control signal of a vehicle, and transmitting a high-frequency light source synchronized with an operating frequency and a phase of a LiDAR; and
a 3D image device for
transferring a synchronization signal synchronized with the operating frequency and the phase of the LiDAR to the lighting device,
measuring a phase delay by comparing a phase detected from light received from a subject and the phase provided to the lighting device, and
outputting a distance measurement signal measuring the distance to the subject generated from the measured phase delay as a 3D image signal.

2. The system according to claim 1, further comprising a distance calculation unit for performing a long distance and precise distance calculation by combining the 3D image signal output through the 3D image device.

3. The system according to claim 1, wherein the lighting device is implemented as the LED headlamp of the vehicle.

4. The system according to claim 1, wherein the lighting device includes:
a headlight brightness controller for generating the headlight brightness control signal according to a headlight control signal;
a synchronization signal operator for generating an operating frequency and a phase synchronization signal of the LiDAR according to a reference frequency generated by a reference frequency generator;
a current controller for controlling brightness of the headlight through current control according to the headlight brightness control signal generated by the headlight brightness controller,
and outputting a high-frequency current synchronized with the operating frequency and the phase of the LiDAR generated by the synchronization signal operator; and
a light source transmitter for transmitting a high-frequency light source according to the high-frequency current of the current controller.

5. The system according to claim 4, wherein when the operating frequency and the phase of the LiDAR are changed, the synchronization signal operator also changes the operating frequency and the phase of the high-frequency of the high-frequency light source.

6. The system according to claim 4, wherein the light source transmitter includes an LED for transmitting the high-frequency light source synchronized with the operating frequency and the phase of the LiDAR.

7. The system according to claim 4, wherein the light source transmitter includes:
a first LED for transmitting a light source for the headlamp; and
a second LED for outputting a LiDAR signal synchronized with the operating frequency and the phase of the LiDAR.

8. The system according to claim 1, wherein the 3D image device includes:
a lens for focusing and outputting receiving light reflected from the subject;
a light receiving unit for converting the receiving light focused through the lens into an electrical signal;
a phase discriminator for detecting a phase of the electrical signal output from the light receiving unit in proportion to a frequency generated by a reference frequency generator;
a phase delay measurement device for measuring a phase delay by comparing the phase detected by the phase discriminator with a phase of the high-frequency light source, and generating a distance measurement signal measuring a distance to the subject using the measured phase delay;
a controller for controlling generation of the reference frequency of the reference frequency generator, transferring the phase of the high-frequency light source to the phase delay measurement device, and controlling output of a 3D image; and
a 3D image buffer for buffering the distance measurement signal measuring a distance to the subject output from the phase delay measurement device according to 3D image output control of the controller, and outputting a 3D image signal.

9. The system according to claim 8, wherein the light receiving unit includes a plurality of light receiving elements arranged horizontally and vertically.
